(19) United States
(12) Patent Application Publication
(10) Pub. No.: US 2025/0058864 A1
(43) Pub. Date: Feb. 20, 2025

(54) SOLAR POWERED AQUATIC TRANSLOADING SYSTEM

(71) Applicant: Matthew White, Houston, TX (US)

(72) Inventor: Matthew White, Houston, TX (US)

(21) Appl. No.: 18/234,521

(22) Filed: Aug. 16, 2023

(51) Int. Cl. B63H 21/17

(52) U.S. Cl. CPC B63H 21/17; B63H 2021/171; B63H 2025/028

(57) ABSTRACT

A solar powered aquatic transloading system that includes a first floating vessel having a motor. There is a second floating vessel that includes a first solar panel configured with an at least one photovoltaic cell operable to generate a current. The system has a power network or grid operably coupled between the first floating vessel and the second floating vessel. The power network receives the current from the first solar panel and transfers a suitable output current to the motor.

### BACKGROUND

### Field of the Disclosure

This disclosure generally relates to a solar powered aquatic transloading system. Particular embodiments pertain to a floating vessel, such as a tug, barge, or the like, being powered by solar energy generated during a transloading operation. Other embodiments pertain to an autonomous floating vessel that may provide or otherwise be configured with a floating surface area suitable to accommodate solar energy generation.

### Background of the Disclosure

For at least a decade, the United States and the rest of world enjoyed a period of stable and low energy prices resulting from cheap and reliable energy production. This resulted in global economy sustainable for even the scenario of shipping a consumer product from China to the U.S. being cheaper than the same product being made/shipped within the U.S.

Recently, the world has experienced a global shock to its economic system. Starting with the Covid-19 pandemic, then cascading from work force shortages, supply system disruption, compounded by the Russian invasion into Ukraine, and spiking fuel costs. These and other events have resulted in or attributed to rampant inflation, and significant overall cost increases.

Nowhere more evident is this change than in the shipping industry. The sea carries more than 80 percent of the world's traded goods, most of which sail inside 40-foot-long steel containers stacked by the thousands atop some of the largest vessels ever built. At the same time, river and intercoastal shipping is also a major player in the domestic U.S. for logistics and transloading.

It is well known that transporting goods by barge or ship is a great option, especially for those looking to move bulk items at a low cost. While it is the slowest mode, water transport is environmentally responsible, fuel efficient and has the ability to carry massive amounts of goods of just about any size or weight.

Water transport is ideal for transporting heavy, bulk freight. While weight can be an issue for other modes, it typically is not a problem for water freight. Because of the sheer size or volume of some products being shipped-including grain, minerals, metals, ores, and heavy machinery-ship or barge often makes the most sense. By way of comparison, an average single 15-barge tow is equivalent to the amount carried by approximately 225 railroad cars or 870 tractor-trailer trucks.

Shipping of sand has risen dramatically, as sand is widely used in ever-increasing hydraulic fracturing. In a typical fracking process, sand is suspended in a chemical slurry and pumped thousands of feet underground. The high-pressure fluid cracks open the formation rock, and then sand flows into these fractures and “props” them open, allowing dislodged hydrocarbons (gas and liquids) to seep out. Consumed by the bargeful, sand is cheap, heavy, and essential. A single fracked well in a shale region nay use upwards of several million pounds of it. Mining of frac sand may exceed 100 million metric tons in a given year.

Unfortunately the best sand for fracking is not found near viable hydrocarbon reservoirs. Midwest sand (e.g., Wisconsin, Minnesota, etc.) boasts 99 percent quartz and a compressive strength between 6,000 and 14,000 pounds per square inch, which makes these grains ideally round and durable to prop open underground formations fissured by drilling.

River shipping along the Mississippi is routine. However, similar to other modes (rail, trucking) even this mode has been significantly impacted with skyrocketing costs. According to reported data, the price to move goods via barge has nearly doubled since April 2021.

A change in transportation mode is not a remedy. Green energy such as solar is an unutilized potential solution. In just 90 minutes the amount of sunlight that strikes the surface of the earth is enough to handle the entire world's energy consumption for a full year. Solar radiation is light is emitted by the sun, where the amount of which that reaches any one spot on the earth's surface varies. Solar technologies capture this radiation and turn it into useful forms of energy.

There are two traditional solar energy technologies: photovoltaics (PV) and concentrating solar-thermal power (CSP), with PV being the point of non-limiting discussion here. This type of solar technology converts sunlight into electrical energy either through photovoltaic (PV) panels. When the sun shines onto a solar panel, energy from the sunlight is absorbed by the PV cells in the panel. This energy creates electrical charges that move in response to an internal electrical field in the cell, causing electricity to flow. This energy can then be used to generate electricity or be stored in batteries or thermal storage.

Typically, PV solar panels generate direct current (DC) electricity. With DC electricity, electrons flow in one direction around a circuit; as such an inverter may be used to convert DC into alternating current (AC). Inverters may be a central inverter, micro-inverter, or the like.

FIG. 1 shows a simplified diagram of a solar panel 104 operably connected with a power network 140. The panel 104 may include a rigid or pliable backing or substrate 102 with one or more (PV) cells 105 integrated therewith. As solar radiation S is absorbed by the cells 105, current C is generated and transferrable (such as via wiring, cabling, etc. 106) to the power network 140. The power network 140 includes an inverter 141 (or other optional equipment, such as a battery and so forth) that converts the current C into a usable output 107, usually in the form of DC. The unfortunate downside is that solar power panels require a large footprint in order to generate desirous amounts of electricity, which is why large solar power farms come to mind.

What is needed is a way to reduce aquatic transloading fuel costs by way of large enough solar power foot print.

### SUMMARY

Embodiments of the disclosure pertain to a solar powered aquatic transloading system that may include a first floating vessel comprising a motor; and a second floating vessel comprising a first solar panel configured with an at least one photovoltaic cell operable to generate a current.

There may be a power network or grid operably coupled between the first floating vessel and the second floating vessel. As such, the power network may receive the current from the first solar panel and transfers a suitable output current to a destination, such as the motor. The motor may be an electrical motor, or otherwise be configured to receive and use the suitable output current.

The first floating vessel may be a type of utility vessel, such as a tug boat. The second floating vessel may also be of a similar type of utility vessel, such as a barge.

The system may include at least three floating vessels and no more than ten floating vessels. Any or each vessel may have a respective solar panel having an at least one respective photovoltaic cell.

Each of the floating vessels may have a respective solar panel that is a plurality of solar panel. Any to all of the solar panels are may be in operable communication with the power network.

Either vessel may have a cargo hold. A cargo may be disposed in the cargo hold. A removable cover may be disposed over the cargo hold. The first solar panel may be one of: coupled onto the removable cover or integrated with the removable cover.

These and other embodiments, features and advantages will be apparent in the following detailed description and drawings.

### BRIEF DESCRIPTION OF THE DRAWINGS

A full understanding of embodiments disclosed herein is obtained from the detailed description of the disclosure presented herein below, and the accompanying drawings, which are given by way of illustration only and are not intended to be limitative of the present embodiments, and wherein:

FIG. 1 shows a simplified diagram of a conventional solar panel operably connected with a power network;

FIG. 2A shows a side view of a floating vessel configured with a solar panel according to embodiments of the disclosure;

FIG. 2B shows a downward view of the floating vessel of FIG. 2B according to embodiments of the disclosure;

FIG. 2C shows a simplified diagram view of an aquatic system using a plurality of floating vessels configured with a respective solar panel being pushed according to embodiments of the disclosure;

FIG. 2D shows a simplified diagram view of an aquatic system using a plurality of floating vessels configured with a respective solar panel being pulled according to embodiments of the disclosure;

FIG. 3A shows a component diagram view of an autonomous floating vessel configured with a solar panel according to embodiments of the disclosure;

FIG. 3B shows a downward isometric view of an autonomous floating vessel according to embodiments of the disclosure;

FIG. 3C shows a side view of the autonomous floating vessel of FIG. 3B according to embodiments of the disclosure; and

FIG. 3D shows a simplified diagram view of an aquatic system using a plurality of autonomous floating vessels configured with a respective solar panel for use to power a larger floating vessel according to embodiments of the disclosure.

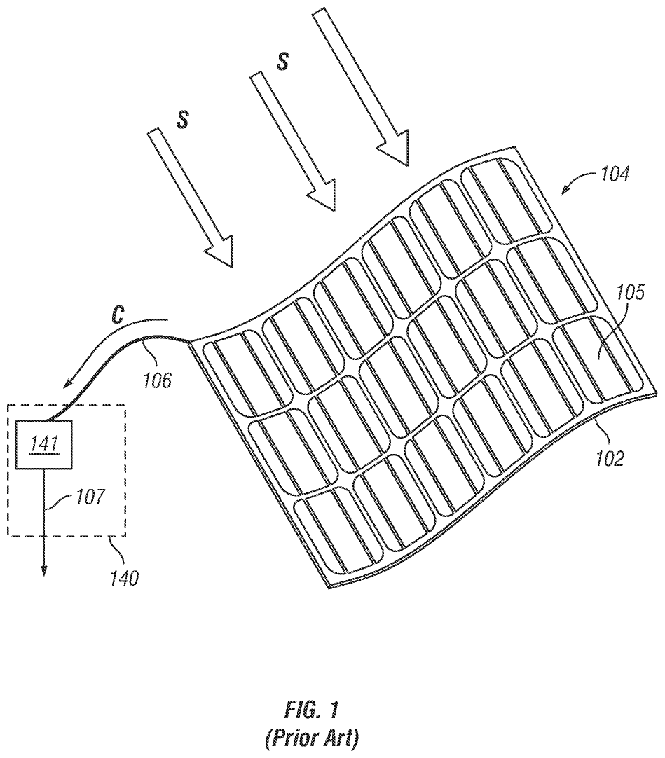

### DETAILED DESCRIPTION

Regardless of whether presently claimed herein or in another application related to or from this application, herein disclosed are novel apparatuses, units, systems, and methods that pertain to improved aquatic floating vessels, details of which are described herein.

Embodiments of the present disclosure are described in detail with reference to the accompanying Figures. In the following discussion and in the claims, the terms “including” and “comprising” are used in an open-ended fashion, such as to mean, for example, “including, but not limited to . . . ”. While the disclosure may be described with reference to relevant apparatuses, systems, and methods, it should be understood that the disclosure is not limited to the specific embodiments shown or described. Rather, one skilled in the art will appreciate that a variety of configurations may be implemented in accordance with embodiments herein.

Although not necessary, like elements in the various figures may be denoted by like reference numerals for consistency and ease of understanding. Numerous specific details are set forth in order to provide a more thorough understanding of the disclosure; however, it will be apparent to one of ordinary skill in the art that the embodiments disclosed herein may be practiced without these specific details. In other instances, well-known features have not been described in detail to avoid unnecessarily complicating the description. Directional terms, such as “above,” “below,” “upper,” “lower,” “front,” “back,” etc., are used for convenience and to refer to general direction and/or orientation, and are only intended for illustrative purposes only, and not to limit the disclosure.

Connection(s), couplings, or other forms of contact between parts, components, and so forth may include conventional items, such as lubricant, additional sealing materials, such as a gasket between flanges, PTFE between threads, and the like. The make and manufacture of any particular component, subcomponent, etc., may be as would be apparent to one of skill in the art, such as molding, forming, press extrusion, machining, or additive manufacturing. Embodiments of the disclosure provide for one or more components to be new, used, and/or retrofitted to existing machines and systems.

Various equipment may be in fluid communication directly or indirectly with other equipment. Fluid communication may occur via one or more transfer lines and respective connectors, couplings, valving, piping, and so forth. Fluid movers, such as pumps, may be utilized as would be apparent to one of skill in the art.

Numerical ranges in this disclosure may be approximate, and thus may include values outside of the range unless otherwise indicated. Numerical ranges include all values from and including the expressed lower and the upper values, in increments of smaller units. As an example, if a compositional, physical or other property, such as, for example, molecular weight, viscosity, melt index, etc., is from 100 to 1,000. it is intended that all individual values, such as 100, 101, 102, etc., and sub ranges, such as 100 to 144, 155 to 170, 197 to 200, etc., are expressly enumerated. It is intended that decimals or fractions thereof be included. For ranges containing values which are less than one or containing fractional numbers greater than one (e.g., 1.1, 1.5, etc.), smaller units may be considered to be 0.0001, 0.001, 0.01, 0.1, etc. as appropriate. These are only examples of what is specifically intended, and all possible combinations of numerical values between the lowest value and the highest value enumerated, are to be considered to be expressly stated in this disclosure. Numerical ranges are provided within this disclosure for, among other things, the relative amount of reactants, surfactants, catalysts, etc. by itself or in a mixture or mass, and various temperature and other process parameters.

### Terms

The term “connected” as used herein may refer to a connection between a respective component (or subcomponent) and another component (or another subcomponent), which can be fixed, movable, direct, indirect, and analogous to engaged, coupled, disposed, etc., and can be by screw, nut/bolt, weld, and so forth. Any use of any form of the terms “connect”, “engage”, “couple”, “attach”, “mount”, etc. or any other term describing an interaction between elements is not meant to limit the interaction to direct interaction between the elements and may also include indirect interaction between the elements described.

The term “mounted” as used herein may refer to a connection between a respective component (or subcomponent) and another component (or another subcomponent), which can be fixed, movable, direct, indirect, and analogous to engaged, coupled, disposed, etc., and can be by screw, nut/bolt, weld, and so forth.

The term “fluid” as used herein may refer to a liquid, gas, slurry, single phase, multi-phase, pure, impure, etc. and is not limited to any particular type of fluid such as hydrocarbons.

The term “fluid connection”, “fluid communication,” “fluidly communicable,” and the like, as used herein may refer to two or more components, systems, etc. being coupled whereby fluid from one may flow or otherwise be transferrable to the other. The coupling may be direct, indirect, selective, alternative, and so forth. For example, valves, flow meters, pumps, mixing tanks, holding tanks, tubulars, separation systems, and the like may be disposed between two or more components that are in fluid communication.

The term “pipe”, “conduit”, “line”, “tubular”, or the like as used herein may refer to any fluid transmission means, and may be tubular in nature.

The term “composition” or “composition of matter” as used herein may refer to one or more ingredients, components, constituents, etc. that make up a material (or material of construction). Composition may refer to a flow stream of one or more chemical components.

The term “chemical” as used herein may analogously mean or be interchangeable to material, chemical material, ingredient, component, chemical component, element, substance, compound, chemical compound, molecule(s), constituent, and so forth and vice versa. Any ‘chemical’ discussed in the present disclosure need not refer to a 100% pure chemical. For example, although ‘water’ may be thought of as H2O, one of skill would appreciate various ions, salts, minerals, impurities, and other substances (including at the ppb level) may be present in ‘water’. A chemical may include all isomeric forms and vice versa (for example, “hexane”, includes all isomers of hexane individually or collectively).

The term “water” or “water medium” as used herein may refer to any portion or area of the earth suitable to support aquatic operations, such as transloading or shipping by boat.

The term “operably connected” or the like may refer to all components, pieces, devices, etc. needed in order for any particular aspect of systems, methods, embodiments, etc. disclosed herein to be operable and work.

The term “skid” as used herein may refer to one or more pieces of equipment operable together for a particular purpose. For example, a ‘mixer skid’ may refer to one or more pieces of equipment operable to provide or facilitate a mixing process for a fluid. A skid may be mobile, portable, or fixed. Although ‘skid’ may refer to a modular arrangement of equipment, as used herein may be mentioned merely for a matter of brevity and simple reference, with no limitation meant. Thus, skid may be comparable or analogous to zone, system, subsystem, and so forth.

The term “skid mounted” as used herein may refer to one or more pieces operable together for a particular purpose that may be associated with a frame- or skid-type structure. Such a structure may be portable or fixed.

The term “engine” as used herein can refer to a machine with moving parts that converts power into motion, such as rotary motion. The engine can be powered by a source, such as internal combustion. The combustion may require a fuel source, such as a diesel mixture.

The term “motor” as used herein can be analogous to engine. The motor can be powered by a source, such as electricity, pneumatic, or hydraulic.

The term “drive” (or drive shaft) as used herein can refer to a mechanism that controls or imparts rotation of a motor(s) or engine(s).

The term “driver” as used herein may refer to a machine, such as a motor or engine, suitable to transfer power (electrical, mechanical, etc.) to a destination, such as a propeller.

The term “photovoltaic cell” as used herein may refer to a semiconductor diode that converts visible light into direct current (DC).

The term “floating vessel” as used herein may refer to any type of vehicle suitable for aquatic use, such as a ship or a boat.

The term “autonomous vessel” or “autonomous floating vessel” as used herein may refer to a ship or boat (such as a cargo ship) that is crewless and is able to transport either containers or bulk cargo over navigable waters with little or no human interaction. Different methods and levels of autonomy can be achieved through monitoring and remote control from a nearby manned ship, an onshore control center, or through artificial intelligence and machine learning.

The term “barge” as used herein may refer to a ship or boat (sometimes ‘flat-bottomed boat) built mainly for river and canal transport of bulk goods. A barge may be self-propelled, usually with a diesel engine and a fixed-pitch propeller, or passive (or unmotorized), and thus towed by tugs, or pushed by pusher boats.

The term “tug” or “tugboat” may be a boat or ship operable to push or pull one or more barges or other floating vessel(s).

The term “geopositioning system” as used herein may refer to the ability to position or otherwise steer a floating vessel, including remotely. The system may include the use of (smart) buoys, satellites, satellite GPS or GNSS, and the like. A geopositioning system may be used for an autonomous (crewless) vessel.

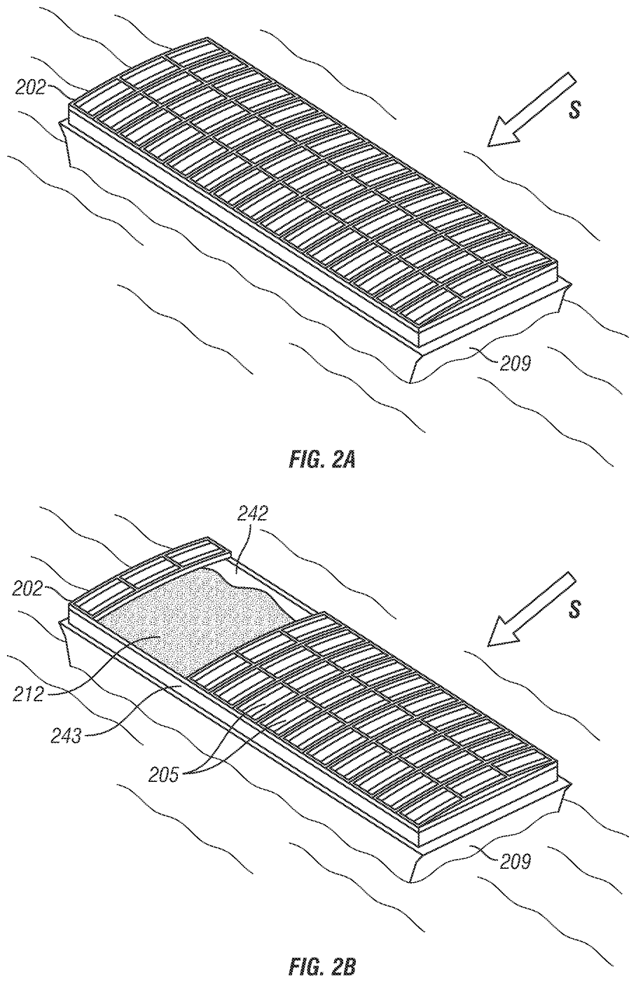

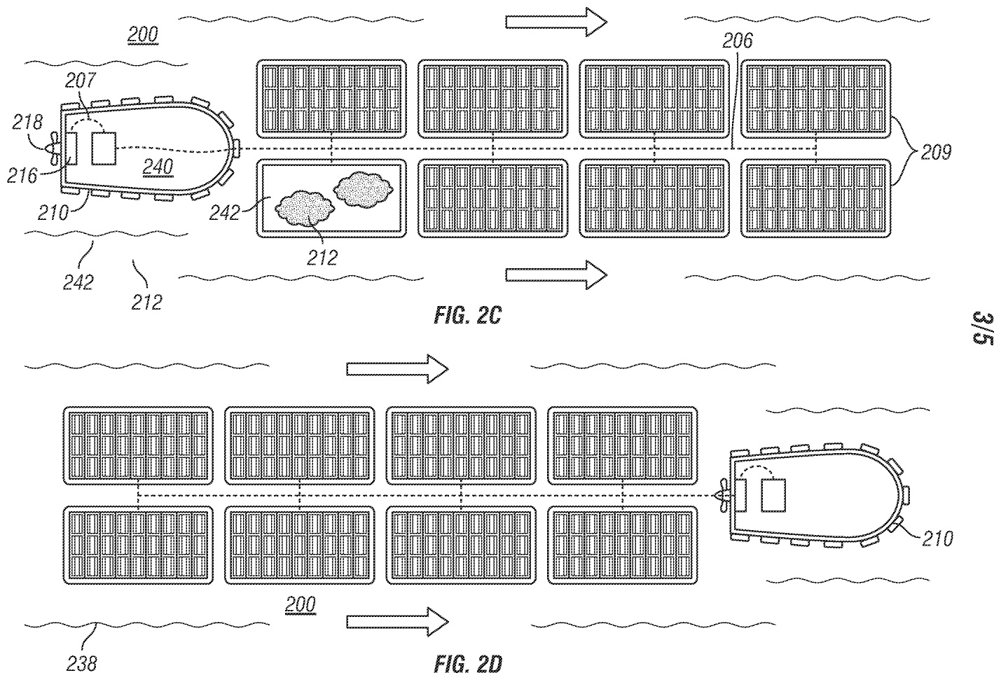

Referring now to FIGS. 2A, 2B, 2C, and 2D together, a side view of a floating vessel configured with a solar panel, a downward view of the floating vessel of FIG. 2B, a simplified diagram view of an aquatic system using a plurality of floating vessels configured with a respective solar panel being pushed, and a simplified diagram view of an aquatic system using a plurality of floating vessels configured with a respective solar panel being pulled, according to embodiments disclosed herein, are shown. System 200 may include one or more components (or subcomponents) coupled with new, existing, or retrofitted equipment. System 200 may include one or more units that are skid mounted or may be a collection of skid units.

FIGS. 2A-2D together show the solar powered aquatic transloading (or shipping) system 200 may include a floating vessel 209. The floating vessel 209 may be suitable for the transfer of a cargo 212, and thus may be a barge or the like. The floating vessel 209 may be passive or unmotorized, and thus not need a motor or propeller. Instead, the floating vessel 209 may be movable via the use of another floating vessel 210. Just the same, the floating vessel 209 could be operable via a motor (not viewable here), which may be inboard, outboard, or both.

System 200 may be suitable for varied aquatic environments that may include a water medium 238 for the floating vessels 209, 210 to move thereon, such as a river, intercoastal waters, a lake, a canal, combinations thereof, and the like.

The floating vessel 209 may have an exterior 243 as well as an interior or cargo hold 242 that may have the cargo 212 disposed therein. While the system 200 need not have the cargo 212, when the cargo 212 is present it may be in non-limiting forms, such as liquidous or solid. The cargo 212 may be agrarian in nature, such as wheat or corn, or may be other utility-type cargo such as sand or fertilizer. The floating vessel 209 may be configured to haul large amounts of cargo 212 akin to a conventional barge.

In order to protect the cargo 212 from external elements, a cover 202 may be used. The cover 202 (which may be configured or otherwise moved to have an opening therein) may be rigid (e.g., metallic) or pliable (e.g., rubber), or a bit of both, such as plastic or plexiglass. While not limited to any particular shape or size, the vessel 209 (and thus the cover 202) may be about 80 feet long and about 20 feet wide, rendering an approximate cover top surface area of about 1600 square feet.

As shown, the cover 202 may be coupled or integrated with a solar panel or module 204. The cover 202 may have a single panel 204 (larger in size) or a plurality of panels (smaller in size, but collectively larger). The panel 204 may include known components, including one or more photovoltaic cells 205, necessary to receive solar radiation S and convert to a current C. Typically the electric current C is going to be direct current. The electric current C may then be fed to a power network 240 that may be operably connected to all components (or subcomponents) of the system 200, such as via cabling or wiring 206 or the like.

The power network 240 may have equipment or components necessary to convert or otherwise turn the current C into a usable output 241. For example, there may be an inverter (or in the event necessary, a converter), as well as an electrical storage or battery. The output 241 may be an AC electrical signal, which may be used to power a motor 216 (and thus turn propeller 218) of the first floating vessel 210. As such, the motor 216 may be an electrical motor. As there may be times where fuel may be used, the motor 216 could be a hybrid motor, or the vessel 210 may have one or more other motors, which may be gas-operable.

The floating vessel 209 may have a solar surface area in a range of about 1000 square feet to about 5000 square feet. FIG. 2C shows how a fleet or plurality of floating vessels 209 may be used to generate power for the first floating vessel 210. All of the vessels 209, 210 may be linked to the point that the motor 216 receives enough power in order to thrust or move the entire fleet. FIG. 2D illustrates a comparable embodiment, but the first floating vessel is towing or pulling the rest of the boats 209 (instead of pushing in 2C).

In accordance with these embodiments, the first floating vessel 210 may include the electrical motor 216. The second or other floating vessel(s) 209 may have its cover 202 configured with the solar panel 204. The solar panel 204 may have one or more of the photovoltaic cells 205.

The storage or electrical unit 241 may be operably coupled between the first floating vessel 210 and the second floating vessel 209. The unit 241 may be or include an inverter, which may be suitable to change DC to AC. The unit 241 may receive the current C from the photovoltaic cells 205, and thereafter transfer usable current 207 to the motor 216.

In aspects, the first floating vessel 210 may be a tug boat, and the second floating vessel 209 may be a barge. As one of skill would appreciate, the vessel 210 may push or pull the passive vessel 209.

The system 200 may include about three floating vessels 209. In the range of solar square foot provided by a given vessel 209, about three may be the suitable needed for the fleet to move with efficiency. The system 200 may include at least three floating vessels 209 and no more than ten floating vessels 209, each having an at least one respective solar panel 204.

The floating vessel 209 may have the cover 202 disposed over the cargo 212 (or the cargo hold 242). The panel 204 may be one of: coupled onto the respective cover 202 or integrated with the cover 202. While the cover 202 may be removable, it could also be the case that the cover 202 is fixedly arranged on the vessel 209 (and thus may have sliding doors or the like).

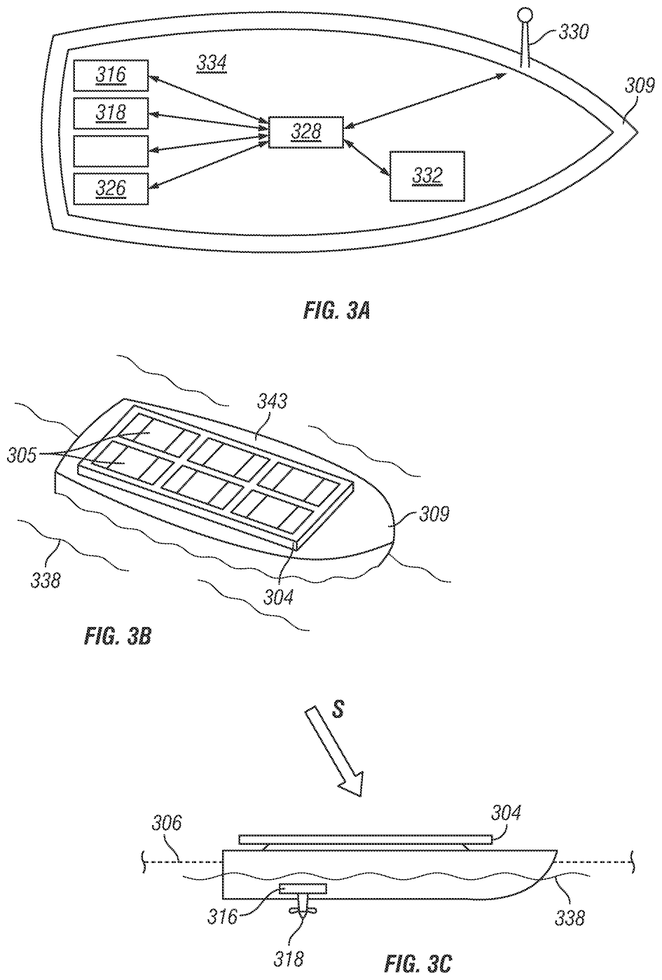

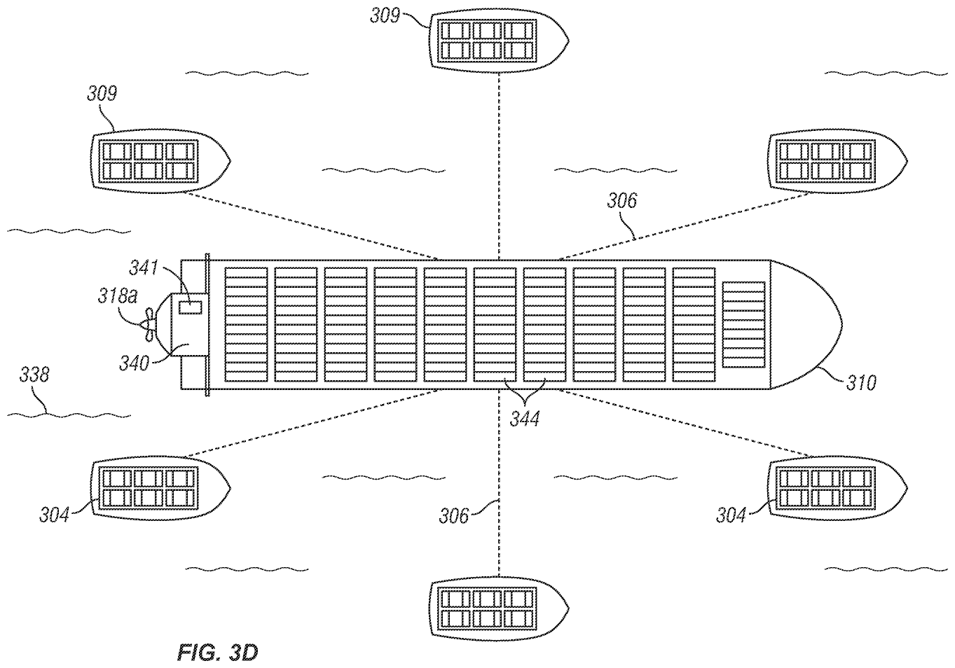

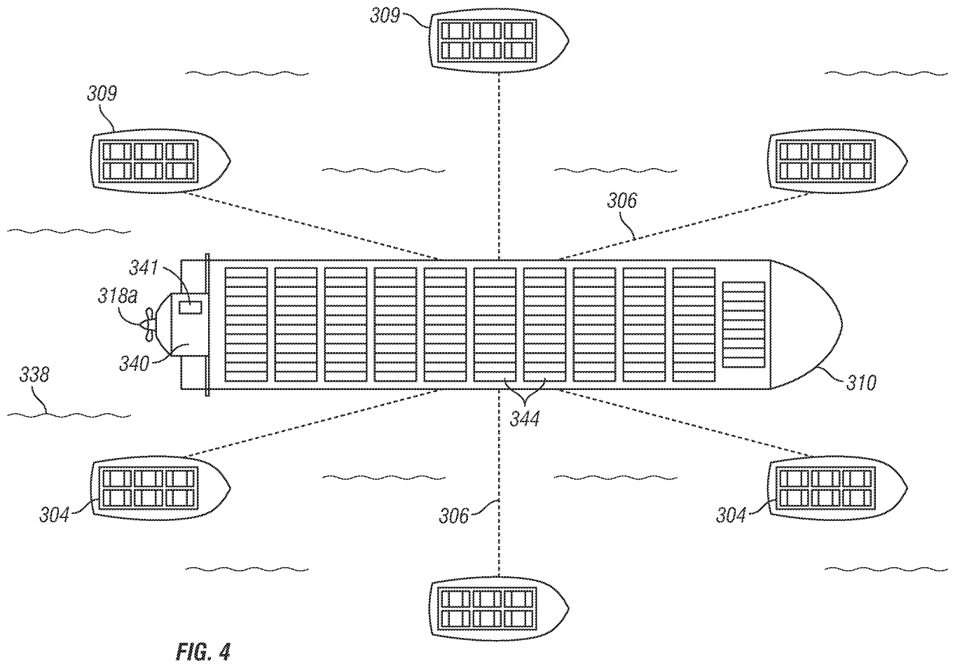

Referring now to FIGS. 3A, 3B, 3C, and 3D together, a component diagram view of an autonomous floating vessel configured with a solar pane, a downward isometric view of an autonomous floating vessel, a side view of the autonomous floating vessel of FIG. 3B, and a simplified diagram view of an aquatic system using a plurality of autonomous floating vessels configured with a respective solar panel for use to power a larger floating vessel, according to embodiments disclosed herein, are shown.

System 300 may include one or more components (or subcomponents) coupled with new, existing, or retrofitted equipment. System 300 may include one or more units that are skid mounted or may be a collection of skid units.

FIGS. 3A-3D together show the solar powered aquatic transloading (or shipping) system 300 may include a floating vessel 309. In contrast to the embodiment described for FIGS. 2A-2D, the floating vessel 309 may be a dedicated power generation vessel, without the presence of anything like cargo. In further contrast, the floating vessel 310 may be a larger ocean faring cargo ship with a fully utilized footprint (usually with hundreds or thousands of 20-foot cargo containers).

As large ocean faring transport ships tend to have fully utilized capacity, they lack the requisite square footage that might otherwise be needed to generate an adequate amount of power. However, it has been discovered that a fleet of dedicated vessels 309 that may accompany the first floating vessel 310 may provide sufficient solar square footage (footprint). Like a dog that powers a sled, the floating vessel 309 may provide power to the first floating vessel 310.

The floating vessel 309 may be autonomous in that there need not be any crew. Instead, the floating vessel 309 may have a computer or CPU 328 for controlling multiple functions of the vessel. As such, the vessel 309 may have guidance or geopositioning system 334 operable therewith. The system 334 may communicate with external devices, such as smart buoys or satellites that help determine with precision the location of the vessel, and any repositioning that may be needed.

The CPU 328 may act as a central hub that can collect and store data from any and all coupled devices or components of system 300. The CPU 328 may act as a two-way communication system to receive and transmit information not only with other components of the vessel 309/310, but other vessels or remote users. In embodiments the CPU(s) 328 may communicate with any or all of the other electronic systems operating on the vessel 309.

Devices or components of the vessel 309 may have a specific role and can be incorporated into the operational routine of the vessel 309 through the CPU 328. The CPU may be associated with a circuit, which may have the ability to generate a calculated value, to filter out noise or to perform other functions. The CPU 328 may be associated with any necessary sensor, transducer, etc. Such devices may be simplistic and common, such as one that measures voltage or a change in voltage, or used to calculate a value such as temperature, pressure, voltage, etc.

The CPU 328 may be operably coupled with the motor (engine) 316, which may have its own respective sensors. For example, the motor 316 may be configured to collect or measure data related to, for example, temperatures of water and/or oil, oil pressure and engine revolutions per minute (RPM).

In certain embodiments, the at least one accelerometer or other type of position detecting device 326. The device 326 may measure or detect the static and dynamic behavior of the vessel 309, which may facilitate autonomous repositioning. The device 326 may be a GPS or GNSS receiver 326 operable to determine the vessel 309 location (i.e., latitude and longitude), speed, direction, true course and time. The GPS 326 could use a standard GPS sensor or other suitable positioning systems could be used, but is not limited.

The vessel 309 may have other auxiliary components in operable communication with the CPU 328, such as a fuel tank or water tank. This may be done, for example, to determine volume of fuel or water present within the tank and pressure within the tank. Another example is weather detection devices operable to measure information related to weather, such as: ambient temperature, relative humidity, barometric pressure, wind speed and/or wind direction.

The CPU 328 may convey or display information to a boat operator, either locally on a GUI 332 or at an interface part of a remote operation center or station. Information about operation of the vessel 309 may be divided into categories such as, for example, position, operation, fuel, course, log, etc.

Embodiments provide for the vessel 309 to provide computer communication at all times, whether close to the shore or in the middle of the ocean. The communications may facilitate the transfer of information from the CPU 328 to other CPUs, computers or servers. This can be accomplished over an internet/Wifi connection or the like. The CPU 328 may provide for constant data transfer, which may be suitable to enable constant monitoring of information concerning the vessel 309.

The floating vessel 309 may generally be passive with respect to the larger floating vessel 310, in that the vessel 309 need not provide any kind of pull or push motion to the vessel 310. Instead, the vessel 309 may have its own motor 316 and propeller 318 for steering and keeping proximity to the vessel 310. The motor 316 and propeller 318 may be outboard or inboard, or in some aspects, there may be one or more of each. The steering may be remote through receiver/transmitter equipment 330. It could also be in some instances that the vessel 309 may require manual operation, and thus a localized GUI or control panel 332 may be used.

The positioning of the vessel 309 may be accommodated by aforementioned GPS/GNSS equipment 326 operable to communicate with external devices, as well as inputs and outputs of CPU 328.

The configuration of the vessel 309 need not look like FIG. 3A, which is merely illustrative of the component nature of the vessel. Instead, it would be desirous to have the vessel 309 provide as much dedicated solar surface area as possible in order to have the largest size solar panel 304 or footprint possible.

System 300 may be suitable for varied aquatic environments that may include a water medium 338 for the floating vessels 309, 310 to move thereon, such as a river, intercoastal waters, a lake, a canal, combinations thereof, and the like. Alas, the contemplated sizing aspects make system 300 quite suitable for ocean or sea faring.

The floating vessel 309 may have an exterior deck or support 343. The deck 343 may have a single panel 304 (larger in size) or a plurality of panels (smaller in size, but collectively larger) coupled with or otherwise disposed thereon. The panel 304 may include known components, including one or more photovoltaic cells 305, necessary to receive solar radiation S and convert to a current C. The electric current C may then be fed to a power network 340 that may be operably connected to all components (or subcomponents) of the system 300, such as via cabling or wiring 306 or the like.

The power network 340 may have equipment or components necessary to convert or otherwise turn the current C into a usable output 307. For example, there may be an inverter (or in the event necessary, a converter), as well as an electrical storage or battery. The output 307 may be an AC electrical signal, which may be used to power a motor 316a (and thus turn propeller 318a) of the first floating vessel 310. As such, the motor 316a may be an electrical motor. As there may be times where fuel may be used, the motor 316a could be a hybrid motor, or the vessel 310 may have one or more other motors, which may be gas-operable.

For example, during daytime ocean fairing, the vessel may use the electric motor 316a, whereas at nighttime or upon moving into intercoastal (and thus disconnecting from vessel(s) 309), the vessel 310 may use a motor run by fuel such as diesel or gasoline.

The floating vessel 309 may have a solar surface area in a range of about 1000 square feet to about 5000 square feet. FIG. 3D shows how a fleet or plurality of floating vessels 309 may be used to generate power for the first floating vessel 310. All of the vessels 309, 310 may be linked to the point that the motor 316a receives enough power in order to thrust itself forward.

In accordance with embodiments herein, the first floating vessel 310 may include the electrical motor 316a. The second or other floating vessel(s) 309 may have its deck or exterior surface 343 configured with the solar panel 304. The solar panel 304 may have one or more of the photovoltaic cells 305.

The storage or electrical unit 341 may be operably coupled between the first floating vessel 310 and the second floating vessel 309. The unit 341 may be or include an inverter, which may be suitable to change DC to AC. The unit 341 may receive the current C from the photovoltaic cells 305, and thereafter transfer usable current 307 to the motor 316a.

In aspects, the first floating vessel 310 may be operating in a range of at least 9 knots to no more than 11 knots. The first floating vessel 310 may be a transoceanic vessel having a transloading capacity in a range of at least 33,000 cubic meters to no more 15 million cubic meters. Any or all of the accompanying vessels 309 may be autonomous non-cargo holding vessels.

The first floating vessel 310 may have a driver 316a configured as one of: an electrical motor and a hybrid combination electric-gas powered motor engine. The electrical network 340 may be operably coupled between the first floating vessel 310 and each of the plurality of other autonomous vessels 309, whereby the current generated is transferrable (directly or indirectly) to the driver 316a. The autonomous vessels 309 may be remotely steerable, such as by human or computer program control, or some combination of each.

As such, the vessel 309 may be in communication with a global geopositioning system that may utilize at least one of buoys, satellites, and combinations thereof.

It is anticipated that the first vessel 310 will have instances where it is completely full of cargo. In embodiments, the transloading capacity is at least 95% utilized with cargo. Each of the plurality of other floating autonomous vessels 309 may include its own respective driver (e.g., electric motor) 316. Any vessel 309 may be operable to generate sufficient current to provide a power range of 200 kilowatts to 300 kilowatts to the network (grid) 340.

### Advantages

Embodiments herein may provide for new and improved systems and methods for transloading. Embodiments herein may provide for a reduction in fuel consumption and shipping costs.

While preferred embodiments of the disclosure have been shown and described, modifications thereof may be made by one skilled in the art without departing from the spirit and teachings of the disclosure. The embodiments described herein are exemplary only and are not intended to be limiting. Many variations and modifications of the embodiments disclosed herein are possible and are within the scope of the disclosure. Where numerical ranges or limitations are expressly stated, such express ranges or limitations should be understood to include iterative ranges or limitations of like magnitude falling within the expressly stated ranges or limitations. The use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the preferred embodiments of the present disclosure. The inclusion or discussion of a reference is not an admission that it is prior art to the present disclosure, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

What is claimed is:

1. A solar powered aquatic transloading system comprising:
a first floating vessel comprising an electrical motor;
a second floating vessel comprising a first solar panel configured with an at least one photovoltaic cell operable to generate a current;
a power network or grid operably coupled between the first floating vessel and the second floating vessel, wherein the power network receives the current from the first solar panel and transfers a suitable output current to the electrical motor.

2. The solar powered aquatic transloading system of claim 1, wherein the first floating vessel comprises a tug boat, and wherein the second floating vessel comprises a barge.

3. The solar powered aquatic transloading system of claim 1, the system further comprising at least three floating vessels and no more than ten floating vessels, each comprising a respective solar panel having an at least one respective photovoltaic cell.

4. The solar powered aquatic transloading system of claim 3, wherein each of the floating vessels having a respective solar panel each further comprise a plurality of solar panel, and wherein all of the solar panels are in operable communication with the power network.

5. The solar powered aquatic transloading system of claim 1, wherein the second floating vessel comprises a barge configured with a cargo hold, wherein a cargo is disposed in the cargo hold, wherein a removable cover is disposed over the cargo hold, and wherein the first solar panel is one of: coupled onto the removable cover or integrated with the removable cover.

6. A solar powered aquatic transloading system comprising:
a first floating vessel comprising an electrical motor;
a plurality of other floating vessels, each comprising a respective solar panel configured with an at least one photovoltaic cell operable to generate a current;
an electrical network operably coupled between the first floating vessel and each of the plurality of other vessels, whereby the current generated is made to a useable form and transferred as an output to the electrical motor.

7. The solar powered aquatic transloading system of claim 6, wherein the first floating vessel comprises a tug boat operating in a range of at least 9 knots to no more than 11 knots, and wherein each of the plurality of other floating vessels comprise a barge.

8. The solar powered aquatic transloading system of claim 7, wherein each of the plurality of other floating vessels is configured with a cargo hold, wherein a respective cargo is disposed in each of the cargo hold, wherein a respective removable cover is disposed over each of the cargo holds, and wherein each of the respective solar panels is one of: coupled onto the respective removable cover or integrated with the respective removable cover.

9. The solar powered aquatic transloading system of claim 8, wherein the current is direct current, and wherein the electrical network comprises an inverter to convert the direct current to alternating current.

10. The solar powered aquatic transloading system of claim 6, wherein the first floating vessel is a transoceanic vessel having a transloading capacity in a range of at least 33,000 cubic meters to no more 15 million cubic meters.

11. The solar powered aquatic transloading system of claim 10, wherein each of the plurality of other floating vessels are autonomous non-cargo holding vessels.

12. The solar powered aquatic transloading system of claim 6, wherein the first floating vessel further comprises an engine powered by diesel, and wherein the first floating vessel does not use battery power.

13. A solar powered aquatic transloading system comprising:
a first floating vessel comprising a driver configured as one of: an electrical motor and a hybrid combination electric-gas powered driver;
a plurality of other floating autonomous vessels, each comprising a respective solar panel configured with an at least one photovoltaic cell operable to generate a current;
an electrical network operably coupled between the first floating vessel and each of the plurality of other autonomous vessels, whereby the current generated is transferrable to the driver.

14. The solar powered aquatic transloading system of claim 13, wherein each of the plurality of other floating autonomous vessels are remotely steerable.

15. The solar powered aquatic transloading system of claim 14, wherein the remotely steerable occurs via a global geopositioning system.

16. The solar powered aquatic transloading system of claim 15, wherein the global geopositioning system comprises use of at least one of buoys, satellites, and combinations thereof.

17. The solar powered aquatic transloading system of claim 13, wherein the first floating vessel is a transoceanic vessel having a transloading capacity in a range of at least 33,000 cubic meters to no more 15 million cubic meters, and wherein the transloading capacity is at least 95% utilized with cargo.

18. The solar powered aquatic transloading system of claim 13, wherein each of the plurality of other floating autonomous vessels comprise its own respective electric motor, and wherein each of the respective solar panels is operable to generate sufficient current to provide a power range of 200 kilowatts to 300 kilowatts to the electrical network.
